(19) United States
(12) Patent Application Publication
(10) Pub. No.: US 2010/0012044 A1
(43) Pub. Date: Jan. 21, 2010

(54) SKIRT FOR AN ANIMAL/FISH TANK STAND

(76) Inventor: Armand P. Ghioni, Somerville, MA (US)

Correspondence Address: ANTOINETTE G. GIUGLIANO, P.C.;DBA AGG Intellectual Property Law, 100 Cummings Center, Suite 213C, Beverly, MA, 01915, US

(21) Appl. No.: 12/177,058

(22) Filed: Jul. 21, 2008

(51) Int. Cl. A01K 63/00

(52) U.S. Cl. 119/247

(57) ABSTRACT

The present invention relates to an animal tank stand skirt for an animal tank stand (e.g., a metal stand). The stand includes four legs having a top portion and a bottom portion, a platform having a front long member, a rear long member, and two short members that connect the top end of each leg to form a rectangular opening to receive an animal tank. The animal tank stand skirt includes two rectangular skirt members, each skirt member has a top end, a bottom end, a first side and a second side; one or more fasteners at the top end of the skirt member; and one or more pockets on an inside portion of the skirt member, at or near the first side. The skirt has an opening at the middle at the first sides of each skirt member; and the skirt has a length and width that fit a standard size tank stand. The present invention further includes methods of use thereof, kits and systems that include the animal tank stand skirt.

### RELATED APPLICATION

This application relates to U.S. design application No. (Not yet assigned, Docket No.: 0079.0002-000), filed on even date herewith, entitled “A Skirt for an Animal/fish Tank Stand”. The entire teachings of the above application are incorporated herein by reference.

### BACKGROUND OF THE INVENTION

Metal or wrought iron fish tank stands are generally less expensive than wooden tank stands, but they are usually not as ascetically pleasing. Additionally, metal stands are known to rust or suffer water damage. Over time these metal stands can become unsightly.

Hence, a need exists for a covering that is ascetically pleasing and hides metal animal tank stands. A further need exists to provide a covering that also protects the stand from water damage.

### SUMMARY OF THE INVENTION

The animal tank stand skirt of the present invention is for an animal tank stand. The stand includes four legs having a top portion and a bottom portion, a platform having a front long member, a rear long member, and two short members that connect the top end of each leg to form an essentially rectangular opening/platform to receive an animal tank. The animal tank stand skirt includes two rectangular skirt members. Each skirt member has a top end, a bottom end, a first side and a second side; one or more fasteners at the top end of the skirt member; and one or more pockets on an inside portion of the skirt member, at or near the first side. The skirt has an opening at the middle at the first sides of each skirt member; and the skirt has a length and width that fit a standard size tank. The skirt has a length of about 29 inches and a width of about 40 inches (5 gallon tank stand), about 44 inches (10 gallon tank stand), about 48 inches (20 gallon tank stand), about 54 inches (29 gallon long tank stand), about 60 inches (30 or 45 high gallon tank stand), about 72 inches (55 gallon tank stand), about 84 inches (75 gallon tank) and about 108 inches (125 gallon tank) to fit a standard size tank. In an embodiment, the skirt is made from or lined with a liquid-proof or liquid resistant material (e.g., a waterproof mat or waterproof foam material). In one aspect, the skirt is pleated. One or more pockets are adapted to receive animal tank accessories (e.g., fish nets, water treatment solutions, water filters and supplies, and/or aquarium supplies) or animal food (e.g., fish food). Examples of fasteners to adhere the skirt to the stand include hook & loop fasteners, snaps, ties, lace, straps, buckles, buttons (e.g., button and strap arrangement), hooks (e.g., hook-to-hook arrangements, snap hooks), elastic members, clips, zippers, drawstring & cord lock arrangements, magnets, and combinations thereof.

The method of using the animal tank stand skirt, as described herein. The steps of the methods include attaching the skirt to the animal tank stand by engaging the fasteners. The steps, in an embodiment, further include removing an animal tank accessory or animal food from the pocket, using the animal tank accessory or animal food, and/or placing the animal tank accessory or animal food back into the pocket.

The present invention further includes systems and kits having the animal tank stand, as described herein, and the animal tank stand skirt, also as described herein. In an embodiment, the system can also include an animal tank that fits on the platform of the animal tank stand. Kits of the present inventions further pertain to one or more animal tank accessories or animal food containers. Examples of animal tank accessories encompass fish nets, water treatment solutions, water filters and supplies, and/or aquarium supplies (e.g., animal tank decorations).

Advantages of the present invention include the ability to cover an unsightly metal tank stand. Additionally, the skirt of the present invention also provides the protection from damage. The skirt of the present invention further advantageously provides storage areas for animal tank accessories or food.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a perspective view of the animal tank stand skirt of the present invention on a tank stand.

FIG. 2 is a front or exterior view of the animal tank stand skirt of the present invention.

FIG. 3 is the back or an interior view of the animal tank stand skirt of the present invention.

### DETAILED DESCRIPTION OF THE INVENTION

A description of preferred embodiments of the invention follows.

The present invention relates to an animal tank stand skirt that fits a metal tank stand. The present invention is designed to cover unsightly metal tank stands, protect the animal tank stand from water damage, and/or provide useful storage areas or pockets that are adapted to receive items normally used with an animal or fish tank. Metal tank stands are often unsightly and incur water damage over time. The skirt of the present invention is specifically designed to cover and protect such stands. The animal stand skirt of the present invention further includes an opening that can be used to access one or more storage pockets on the inside of the skirt. The pockets are adapted to store animal food, such as fish food, and/or animal tank accessories, e.g., fish nets, water treatment solutions, water filters and supplies, and/or aquarium supplies (e.g., animal tank decorations).

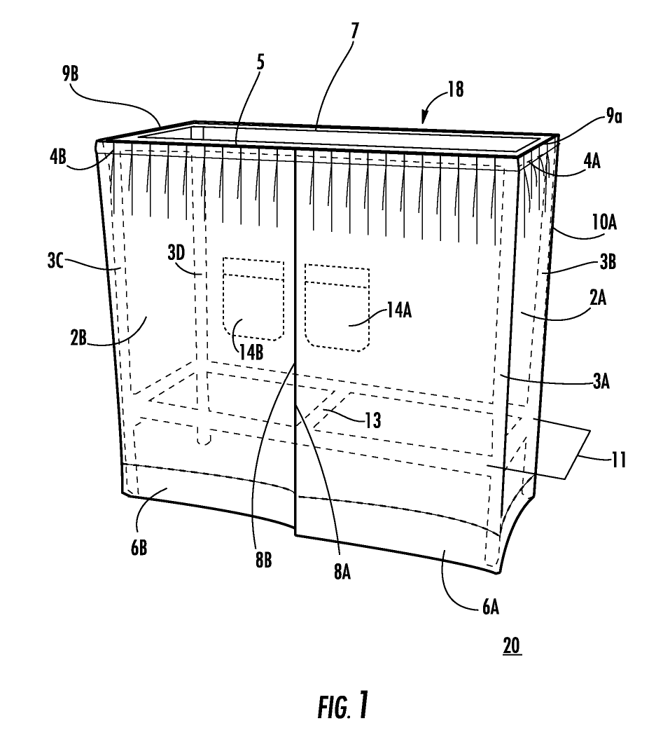

Referring to FIG. 1, the animal tank stand is a metal tank stand that includes a rectangular base 11 with cross bar 13, and a rectangular platform that includes a front long member 5, rear long member 7, and two short members 9A and 9B. The tank stand also includes legs 3A-3D. Each leg has a top portion and a bottom portion. The long members and short members of the platform are connected at the top end of each of the legs to form the rectangular opening that receives the animal tank (not shown). Rectangular animal tanks come in standards sizes that include, e.g., 5, 10, 20, 29, 30, 45, 55, 75, and 125 gallon tanks. These tanks utilize stands with the following dimensions (width×depth×height in inches): 16″×12″×30″ (5 gallon tank); 20″×12″×30″ (10 gallon tank), 24×12×30 (20 gallon tank), 30″×12″×30″ (29 gallon tank), 36″×12″×30″ (30 gallon tank or 45 gallon high tank), 48″×12″×30″ (55 gallon tank), 48″×18″×30″ (75 gallon tank), and 72″×18″×30″ (125 gallon tank). The metal tank stands are often made from wrought iron, aluminum, and metal alloy, but can be made from any material now known or developed in the future so long as it supports an animal tank. The members and/or legs of the tank stand can be solid or hollow, and in an embodiment are welded together.

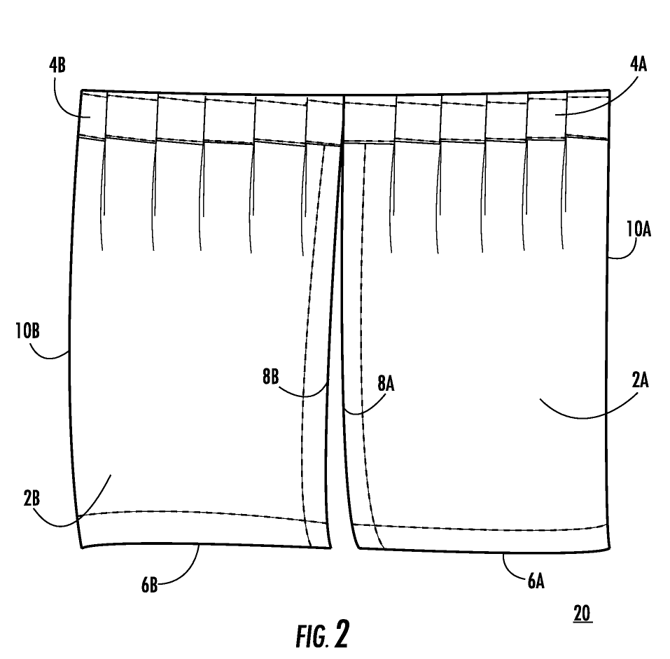

Referring to FIGS. 1 and 2, the animal tank stand skirt has skirt members 2A and 2B. The skirt members have a generally rectangular shape with top ends 4A and 4B and bottom ends 6A and 6B. The dimensions of the skirt members have specific lengths and widths to fit a standard size animal tank stand. Specifically, the top and bottom ends of a single skirt member can have any one of the following widths to accommodate a standard size tank stand: about 20 inches (5 gallon tank stand), about 22 inches (10 gallon tank stand), about 24 inches (20 gallon tank stand), about 27 inches (29 gallon tank stand), about 30 inches (30 or 45 high gallon tank stand), about 36 inches (55 gallon tank stand), about 42 inches (75 gallon tank stand), and about 54 inches (125 gallon tank stand).

In another embodiment, the width of the skirt members can be adjusted to fit the size of tank stand being used. The skirt can include one or more fasteners to allow the user to adjust the width to fit the tank stand being used. Demarcations can be included on the inside of the skirt to indicate where to fasten the edge (e.g., second sides 10A and 10B) of the skirt for the corresponding tank stand size. In an example, second sides 10A and 10B include one or more ends of hook and loop fasteners and can be inwardly folded and attached to the corresponding end of the fastener so that the width fits the tank size. A series of the hook and loop fastener ends can be positioned along the width of the skirt, each demarcated with the corresponding tank size (e.g., “5 gallon tank”, “10 gallon tank”, etc.). The width adjuster can be a hook & loop fastener, a series of eye/hook arrangements, a series of snaps, buttons, ties, clips, and the like.

The two skirt members together form the animal tank stand skirt of the present invention, and their combined width covers a standard size tank stand. As such, the width of the entire skirt (e.g., the combined distance of top ends 4A and 4B of both skirt members) to accommodate standard size tank stands are as follows: about 40 inches (5 gallon tank stand), about 44 inches (10 gallon tank stand), about 48 inches (20 gallon tank stand), about 54 inches (29 gallon tank stand), about 60 inches (30 or 45 high gallon tank stand), about 72 inches (55 gallon tank stand), about 84 inches (75 gallon tank stand), and about 108 inches (125 gallon tank stand).

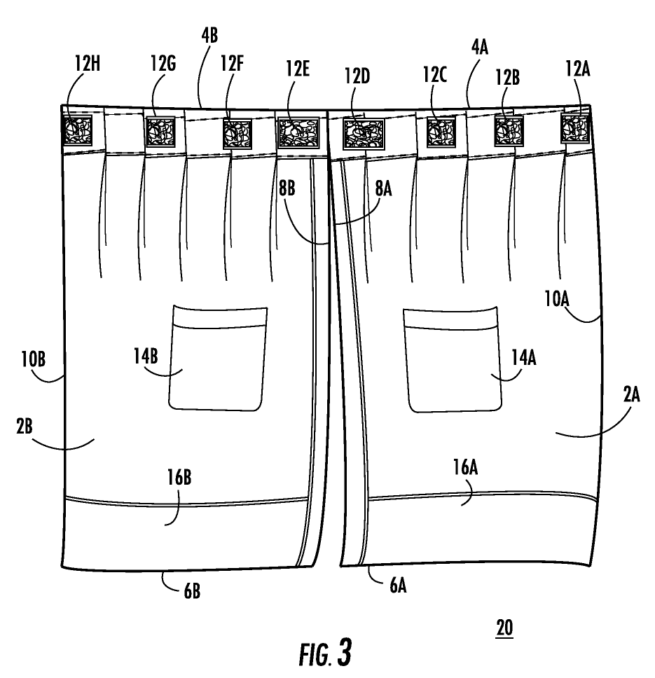

The skirt members further include first sides 8A and 8B and second sides 10A and 10B. The height of a standard animal stand is often about 30 inches. Accordingly, the length of first sides 8A and 8B and second sides 10A and 10B is also about 29 inches. In an embodiment, the hem is sewn in place so that the height of the skirt is about 29 inches. In another embodiment, the hem of the skirt, hems 16A and 16B (shown in FIG. 3), can be an adjustable hem to accommodate stands that are shorter or taller. More specifically, the hem of the skirt can be adjusted to accommodate a height of about 24 inches to about 36 inches. The hem of the skirt can be adjusted using a hem or height adjuster attached to the inside portion of the skirt members. For example, the hem adjuster can be a hook & loop fastener, a series of eye/hook arrangements, a series of snaps, buttons, ties, clips, and the like. Any adjustable device can be used to adjust the height of the skirt members.

The skirt can be made from any fabric including cotton, polyester, linen, vinyl, resin, plastic, blends thereof or combinations thereof. In an embodiment, the fabric can have or be lined with a water resistant or water proof material (not shown) e.g., made from resin or vinyl. Water resistant (e.g., liquid resistant) refers to material that allows less liquid to permeate the fabric (e.g., less porous) than one that is not liquid-resistant. Liquid-resistant material includes material that reduces liquid from flowing through the material. Liquid-proof (e.g., waterproof) material refers to material prevents liquid from flowing through the material. Such liquid resistant or liquid proof materials are known in the art and can be obtained from a number of manufacturers. In an example, the skirt members can be lined with a bendable, liquid resistant/proof, foam material. Examples of such liquid-resistant materials include polyvinyl chloride (e.g., material used for a yoga mat), polyethylene, polyurethane coated nylon, polyester, rubber or plastic. Such fabrics can be obtained, e.g., from Seattle Fabrics (Seattle, Wash.) or Jiunn-Jang (Tien-Chung, Taiwan). Liquid-resistant materials now known or later developed can be used with the present invention.

An embodiment includes a skirt made from or lined with a material that bends or is formed around the stand. A bendable, liquid resistant or liquid proof foam material protects the stand from damage, both water damage and physical damage. Other water proof or water resistant material can be used to line the inner region of the skirt so long it is also bendable or pliable so that it can be formed or fitted around the tank stand. A water proof or protective liner can be placed on, attached to, placed within, or woven into all or a portion the inside of each skirt member. For example, the protective liner can be placed on the entire inside of the skirt members, or the top portion of the inside of the skirt (e.g., the area where water damage is most likely to occur).

Top ends 4A and 4B are pleated. The pleats are created, for example, by folding the fabric and sewing the folded fabric to maintain the pleat. In an embodiment, the pleats are optional. The width of top and bottom ends described herein refer to the width of the finished product, and not of the skirt prior to the sewing the pleats.

Regarding FIG. 3, the inside view of the skirt of the present invention is shown. The present embodiment employs a plurality of hook & loop fasteners. The inside portion of the skirt members includes a series of loop fastener ends 12A-H. A series of corresponding hook fastener ends (not shown) can be attached to the animal tank stand, e.g., via an adhesive. When in use, the user attaches the hook fastener ends to the tank stand and then attaches a corresponding loop fastener end of the skirt members to the hook fastener ends. Any type of fastener can be used so long as the fastener can be used to attach the top end of the skirt to the front long member and short side members of the tank stand. Examples of other fasteners include snaps, ties, lace, straps, buckles, buttons (e.g., button and strap arrangement), hooks (e.g., hook-to-hook arrangements, snap hooks), elastic members, clips, zippers, drawstring & cord lock arrangements, hook & loop fasteners, magnets, and combinations thereof.

The complementary portion of the certain fastener can be attached to the metal stand members using an adhesive. Other fasteners can be attached by tying to or wrapping the fastener or material to which the fastener is attached around the front and side members. One or more fasteners can be used to attach the skirt to the tank stand. When more than one fastener is used, in one aspect, they can be placed periodically along the top edge, or placed in strategic areas (e.g, at the ends of the top edge of the skirt, and at the point at which the skirt bends around the corner of the stand when attached). In another embodiment, the top edge is fastened with a continuous fastener, e.g., a hook and loop fastener. Fasteners are generally placed such that the skirt can be adhered to the tank stand without substantial gaps between the skirt and the tank stand.

Pockets 16A and 16B are on the inside or interior portion of each of the skirt members. One or more pockets or storage areas can be attached to one or both skirt members. The pockets are adapted to hold items or accessories normally used with an animal tank. Such items include animal or fish food, animal tank accessories like fish nets, water treatment solutions, water filters and supplies, and/or aquarium supplies. The pockets or storage areas that are built into the skirt are adapted to fit fish food containers. Specifically, the pockets are large enough and/or deep enough to hold cylindrically shaped fish food containers, fish nets, and water treatment bottles. In an embodiment, the pockets have a length ranging between about 4 inches and about 12 inches, and a width ranging between about 4 inches and about 12 inches. In an embodiment, the pockets are sewn to the skirt member. In another embodiment, the pockets are attached at the top seam or top lip, so that the pockets are free floating pockets. In this embodiment, the pockets or their stitching cannot be seen from the front of the skirt. In the case in which a waterproof or water resistant liner is used, the pocket or storage area can be attached to the liner, or if attached to the skirt member can be accessed via an opening (e.g., a re-closeable opening) through the liner. In a preferred embodiment, the pocket or storage area is positioned near the opening of the skirt, e.g., near the middle of the skirt at first sides 8A and 8B for easy access.

Storage areas can further include fasteners or a holder to secure such items to an inside area of the skirt. For example, a hook and loop fastener can be placed on the inside of a skirt member and which is strapped around, e.g., a fish net handle for storage. Other examples of devices that can secure animal tank accessories or animal food include elastic members or bands, hooks, loops, ties, and the like.

An opening at the middle of the skirt exists and it is located where the two skirt members meet at first sides 8A and 8B. The opening between the skirt members allows, as described herein, one to access the storage areas or pockets on the inside portion of the skirt and/or shelving of the stand. The opening, in one embodiment, goes along the entire height of the skirt, in which case there are two separate skirt members, as shown in the figures. However, in other embodiments, the opening can extend along a portion of the skirt height. The opening can be a re-closable opening (e.g., with the use of fasteners), and can vertically extend along all or a portion of the skirt height. In yet another embodiment, the opening extends horizontally, diagonally, or in any direction. The opening is large enough to allow one to reach into the storage area and remove or place therein one or more items related to the animal tank or the animal being housed in the tank.

The present invention further includes methods of using the animal tank stand skirt described herein. The methods include attaching the skirt to the animal tank stand using the fasteners. Specifically, the methods include fastening the skirt to the animal tank stand. The methods further include storing animal tank related items in the storage areas and/or pockets. Accordingly, the methods involve placing one or more items in the pockets, and when needed, removing the item from the pocket for use. The items can be placed back into the pocket after use.

The present invention also relates to systems and kits that include the animal tank stand skirt of the present invention. The system includes the skirt, as described herein, the tank stand, and the animal tank that fits into the stand. The kit includes the skirt of the present invention, and can further include any one of the following: the tank, the tank stand, animal or fish food, and/or animal tank accessories (e.g., fish nets, water treatment solutions, water filters and supplies, and/or aquarium supplies).

### EXEMPLIFICATION

The animal tank stand skirt shown in the figures was made. Cotton material was cut and sewn as shown the figures. The top edge of the skirt was folded and sewn to form 19 pleats, a ¼ inch each. The bottom and side edges were hemmed and sewn in place. The dimension of one skirt member measured about 25 inches in width and about 29 inches in height. Eight loop fasteners were used in the invention. The loop portion of the fastener was sewn on the top edge of the skirt. The hook portion of the fastener was used for attachment to the stand via an adhesive. Two pockets, each measuring 9″ by 6″ inches, were sewn across the top inside portion of each skirt and hung, free floating, on inside portion of the skirt.

The relevant teachings of all the references, patents and/or patent applications cited herein are incorporated herein by reference in their entirety.

While this invention has been particularly shown and described with references to preferred embodiments thereof, it will be understood by those skilled in the art that various changes in form and details may be made therein without departing from the scope of the invention encompassed by the appended claims.

What is claimed is:

1. An animal tank stand skirt for an animal tank stand, wherein the stand includes four legs having a top portion and a bottom portion, a platform having a front long member, a rear long member, and two short members that connect the top end of each leg to form a rectangular opening to receive an animal tank; the animal tank stand skirt comprises two rectangular skirt members, each skirt member comprises:
a. a top end, a bottom end, a first side and a second side;
b. one or more fasteners at the top end of the skirt member; and
c. one or more pockets on an inside portion of the skirt member, at or near the first side;
wherein the skirt has an opening at the middle at the first sides of each skirt member; and the skirt has a length and width that fit a standard size tank stand.

2. The animal tank stand skirt of claim 1, wherein the skirt has a length of 29 inches and a width of 40, 44, 48, 54, 60, 72, 84, or 108 inches.

3. The animal tank stand skirt of claim 1, further including an adjuster to adjust the length, width or both of the skirt.

4. The animal tank stand skirt of claim 1, wherein the skirt is made from or lined with a liquid-proof or liquid resistant material.

5. The animal tank stand skirt of claim 4, wherein the skirt is lined with a polyvinyl chloride material.

6. The animal tank stand skirt of claim 1, wherein the skirt is pleated.

7. The animal tank stand skirt of claim 1, wherein one or more pockets are adapted to receive animal tank accessories or animal food.

8. The animal tank stand skirt of claim 1, further including one or more hook and loop fasteners.

9. A method of using the animal tank stand skirt, wherein an animal tank stand includes four legs having a top portion and a bottom portion, a platform having a front long member, a rear long member, and two short members that connect the top end of each leg to form a rectangular opening to receive an animal tank; and the animal tank stand skirt comprises two rectangular skirt members, wherein each skirt member includes a top end, a bottom end, a first side and a second side; one or more fasteners at the top end of the skirt member; and one or more pockets on an inside portion of the skirt member, at or near the first side; wherein the skirt has an opening at the middle at the first sides of each skirt member; and the skirt has a length and width that fit a standard size tank stand; the steps of the method comprises:
attaching the skirt to the animal tank stand by engaging the fasteners.

10. The method of claim 9, further including removing an animal tank accessory or animal food from the pocket, using the animal tank accessory or animal food, and placing the animal tank accessory or animal food back into the pocket.

11. An animal tank stand and skirt system that comprises:
a. an animal tank stand that comprises four legs having a top portion and a bottom portion, a platform having a front long member, a rear long member, and two short members that connect the top end of each leg to form a rectangular opening to receive an animal tank; and
b. an animal tank stand skirt comprises two rectangular skirt members, each skirt member comprises:
i. a top end, a bottom end, a first side and a second side;
ii. one or more fasteners at the top end of the skirt member; and
iii. one or more pockets on an inside portion of the skirt member, at or near the first side;
wherein the skirt has an opening at the middle at the first sides of each skirt member; and the skirt has a length and width that fit a standard size tank stand.

12. The animal tank stand and skirt system of claim 11, further comprising an animal tank that fits on the platform of the animal tank stand.

13. A kit for an animal tank stand and skirt, the kit comprises:
a. an animal tank stand includes four legs having a top portion and a bottom portion, a platform having a front long member, a rear long member, and two short members that connect the top end of each leg to form a rectangular opening to receive an animal tank; and
b. an animal tank stand skirt comprises two rectangular skirt members, each skirt member comprises:
i. a top end, a bottom end, a first side and a second side;
ii. one or more fasteners at the top end of the skirt member; and
iii. one or more pockets on an inside portion of the skirt member, at or near the first side;
wherein the skirt has an opening at the middle at the first sides of each skirt member; and the skirt has a length and width that fit a standard size tank stand; and
c. an animal tank accessory or animal food.

14. The kit of claim 13, wherein the animal tank accessory includes a fish net, a water treatment solution, a water filter, water filter supplies, or aquarium supplies.
